(19) United States
(12) Patent Application Publication
(10) Pub. No.: US 2015/0074693 A1
(43) Pub. Date: Mar. 12, 2015

(54) CONTENT VIEWING SYSTEM AND DEVICE

(71) Applicant: Junya ENOMOTO, Tokyo (JP)

(72) Inventor: Junya ENOMOTO, Tokyo (JP)

(21) Appl. No.: 14/539,137

(22) Filed: Nov. 12, 2014

Related U.S. Application Data
(63) Continuation of application No. PCT/JP2013/052281, filed on Jan. 31, 2013.

(30) Foreign Application Priority Data
May 13, 2012 (JP) 2012-110147

(51) Int. Cl. H04N 21/2543; H04N 21/61; H04N 21/258

(52) U.S. Cl. CPC H04N 21/2543; H04N 21/25816; H04N 21/6156
USPC 725/1

(57) ABSTRACT

A control device acquires from the content server options for purchasable video contents to display the options, accepts from an input unit a manipulation for determination of a video content to be purchased out of the options, and sends the viewing device a control event. A viewing device executes purchase processing for the video content, which is determined to be purchased, on the basis of the control event received from the control device, acquires the purchased video content from the content server, and plays the video content on the output unit. The control device further causes a control event to control the play of the video content by the viewing device, and sends the viewing device the control event. The viewing device controls the play of the video content on the basis of the control event received from the control device.

### CROSS REFERENCE TO RELATED APPLICATIONS

This application is a continuation application of International Application No. PCT/JP2013/052281, filed on Jan. 31, 2013, entitled “CONTENT VIEWING SYSTEM AND DEVICE”, which claims priority based on Article 8 of Patent Cooperation Treaty from prior Japanese Patent Application No. 2012-110147, filed on May 13, 2012, the entire contents of which are incorporated herein by reference.

### TECHNICAL FIELD

The invention relates to a content viewing system designed to enable a content purchased through the Internet to be viewed by playing the content on a television monitor or the like.

### BACKGROUND ART

An Apple TV (registered trademark) system is known as a conventional example of this type. In this system, a digital media receiver provided with a function to connect to a network is connected to a television monitor, and the digital media receiver acquires contents from a server on the Internet and plays the contents on the television monitor. Manipulations by a user for selection of a content and the like are performed by use of a dedicated remote controller which is an accessory for the digital media receiver or by an application (an app) installed on a mobile terminal such as a smartphone in order to provide the mobile terminal with a function corresponding to the remote controller. Communication with the content server is solely performed by the digital media receiver. Here, the dedicated remote controller does not have a function for direct communications with the content server. The prior art documents related to the above-described system include Patent Documents 1 to 3, for example.

The digital media receiver has an approximately 10-centimeter square size, which can be called a palm-size. Nevertheless, considering the need for easily carrying the digital media receiver and using it outside, a housing even smaller than ever before is demanded.

### PRIOR ART LIST

Patent Document 1: Published Japanese Translation of PCT International Application No. 2011-508933

Patent Document 2: Published Japanese Translation of PCT International Application No. 2012-509028

Patent Document 3: Published Japanese Translation of PCT International Application No. 2012-509031

### SUMMARY OF THE INVENTION

An object of the invention is to mitigate the aforementioned inconvenience of the conventional example, specifically, to construct a content viewing system by using a device corresponding to a digital media receiver with a smaller housing size than ever before.

An aspect of the invention provides a content viewing system that includes: a viewing device configured to cause an output unit to play a video content acquired from a content server; and a control device configured to control the viewing device.

The control device communicates with the content server, acquires from the content server options for purchasable video contents, causes a display unit to display the options, accepts from an input unit a manipulation for determination of a video content to be purchased out of the options, and sends the viewing device a control event caused from the manipulation for determination.

The viewing device executes purchase processing for the video content, which is determined to be purchased, on the basis of the control event received from the control device by communication with any of the content server and a transaction server cooperating with the content server, acquires the purchased video content from the content server, and plays the video content on the output unit.

Furthermore, the control device further causes a control event to control the play of the video content by the viewing device, and sends the viewing device the control event.

The viewing device controls the play of the video content on the basis of the control event received from the control device.

### BRIEF DESCRIPTION OF THE DRAWINGS

FIG. 1 is a schematic configuration diagram illustrating an embodiment of the invention.

FIG. 2 is an explanatory view illustrating operations of the embodiment of FIG. 1.

FIG. 3 is an explanatory view illustrating operations of the embodiment of FIG. 1.

FIG. 4 is a schematic configuration diagram of a control device illustrated in FIG. 1.

FIG. 5 is a schematic configuration diagram of a viewing device illustrated in FIG. 1.

### EMBODIMENTS

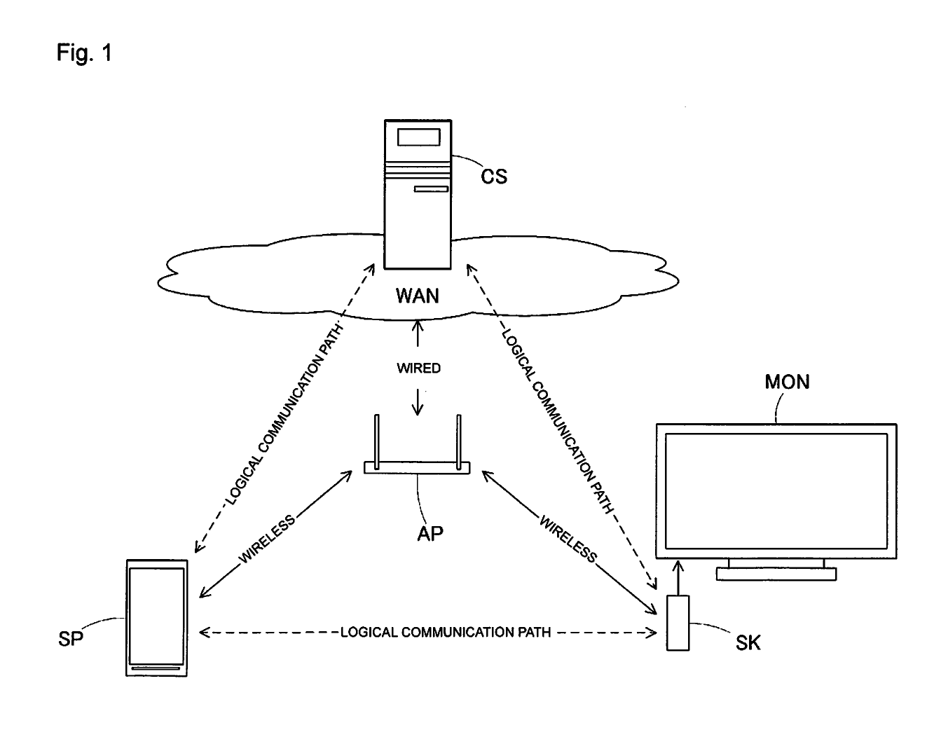

An embodiment of the invention is described below. FIG. 1 is a configuration diagram of a content viewing system of the embodiment. Viewing device SK is connected to television monitor MON. Viewing device SK outputs video signals and audio signals to monitor MON. In the embodiment, viewing device SK corresponds to a digital media receiver. Viewing device SK performs wireless communication in compliance with Wi-Fi (Wireless Fidelity) with control device SP via wireless LAN (Local Area Network) access point AP. Meanwhile, access point AP is connected by wire to a WAN (Wide Area Network). The WAN is provided with content server CS, and control device SP communicates with content server CS via access point AP. Meanwhile, viewing device SK also communicates with content server CS via access point AP.

The communication between control device SP and viewing device SK is permitted by mutual authentication of both of the devices, and is performed via a logical communication path. Similarly, each of the communication between control device SP and content server CS and the communication between viewing device SK and content server CS is permitted by mutual authentication of the devices, and is performed via a logical communication path.

In the embodiment, control device SP is prepared by installing a given application (an app) on a smartphone provided with a Wi-Fi interface. Meanwhile, viewing device SK is housed in a stick-shaped housing substantially in the same size as a commercially available USB memory. A width of the stick may be around 23 mm while its length may be around 65 mm. The housing incorporates the Wi-Fi interface, and also includes a HDMI (High-Definition Multimedia Interface) terminal for video and audio outputs.

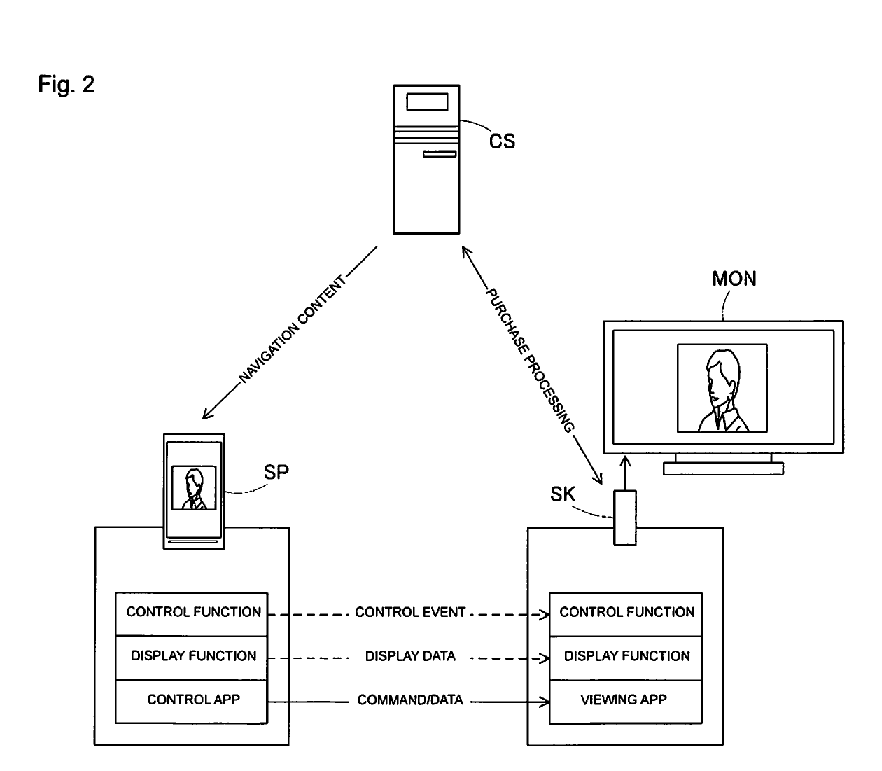

FIG. 2 illustrates a relation between an application used in control device SP and an application used in viewing device SK. In control device SP, a control app is started by a manipulation of an input unit by a user. On the other hand, in viewing device SK, a viewing app is started when viewing device SK is turned on, and authentication processing is started for establishing the logical communication path described above. The logical communication path is established between the control app and the viewing app upon completion of the processing by the control app and the viewing app to authenticate each other. In the meantime, authentication is performed between the control app and content server CS, whereby the logical communication path is established between the control app and content server CS. Similarly, authentication is performed between the viewing app and content server CS, whereby the logical communication path is established between the viewing app and content server CS.

Subsequently, the control app starts a display function and a control function of control device SP. Meanwhile, the control app passes a program for the display function and a program for the control function on to viewing device SK, and instructs the viewing app to install the display function and the control function on viewing device SK so as to execute the functions. Thus, the display function and the control function which are the same as the display function and the control function to operate by the control app are also started in viewing device SK. The control app can also issue an instruction for unintallation of the functions installed by the viewing app, while the viewing app is also provided with a function to uninstall the functions thus instructed.

Display data of information to be displayed on a display unit of control device SP by the display function of control device SP is also passed on from the display function of control device SP to the display function of viewing device SK. The display function of viewing device SK displays on monitor MON the same information as the information to be displayed on the display unit of control device SP. Similarly, a control event caused at control device SP is also passed on from the control function of control device SP to the control function of viewing device SK. The control function of viewing device SK processes the same control event as the control event caused at control device SP.

As described above, the display unit of control device SP and monitor MON connected to viewing device SK display the same information byway of the synchronous cooperation between the display function of control device SP and the display function of viewing device SK. In addition, control device SP and viewing device SK process the same control event by way of the synchronous cooperation between the control function of control device SP and the control function of viewing device SK. For example, when the user changes a display on the display unit at the flick of the display by using the input unit of control device SP, a display on monitor MON connected to viewing device SK also exhibits a change in the display in accordance with the flick.

In the meantime, control device SP acquires from content server CS a navigation content that displays a list of viewable contents, and stores the navigation content in a storage unit. The display function of control device SP causes the display unit to display the acquired navigation content, and also passes the navigation content on to the display function of viewing device SK. Upon receipt of the navigation content, the display function of viewing device SK displays on monitor MON the same navigation content as that to be displayed on the display unit of control device SP.

By manipulating the input unit, the user of control device SP selects a content that the user wants to view by using the navigation content displayed on the display unit, and determines a purchase of the content. The control app transmits an identifier for the content that the user determines to purchase to the content server, and acquires detailed information on the content that is determined to be purchased as a response thereto from content server CS. The display function of control device SP displays the detailed information on the content on the display unit. Here, the control event caused by the manipulation of the input unit by the user in order to purchase the content is transmitted from the control function of control device SP to the control function of viewing device SK. For this reason, the processing of the same control event as that in control device SP is also executed by viewing device SK. As a consequence, the viewing app of viewing device SK specifies the content that the user of control device SP determines to purchase. Then, the viewing app executes processing for the purchase, such as a rental, of the specified content. Upon completion of transaction authentication processing between the viewing app and a transaction server that cooperates with content server CS, the purchased content is delivered from content server CS to the viewing app.

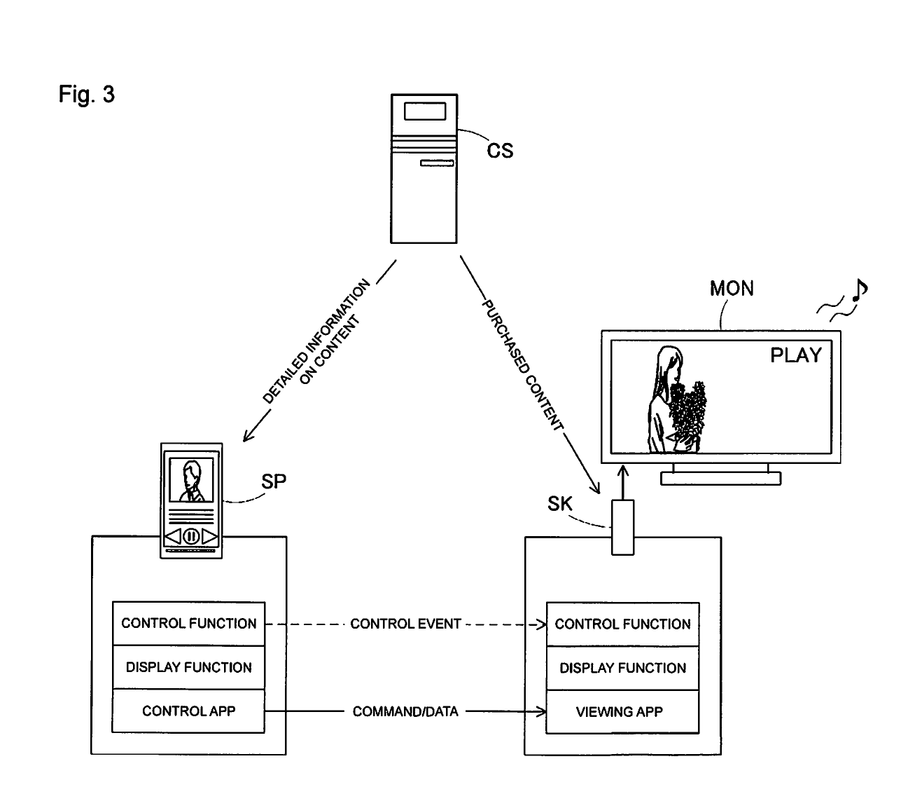

Upon completion of the transaction authentication processing, a viewing license key for the purchased content is delivered from content server CS to the viewing app. In addition, as illustrated in FIG. 3, the purchased content is transmitted from the content server to the viewing app, and the viewing app performs streaming play of the purchased content on monitor MON. Note that viewing device SK is also provided with a function to download and save a set of purchased contents in a storage unit and to play the contents afterwards. Meanwhile, the detailed information on the content purchased can be browsed on control device SP as described above. Here, in order for viewing device SK to play a content downloaded in advance, the communication between control device SP and viewing device SK may be performed by Wi-Fi Direct connection.

While the purchased content is being played, the control app of control device SP accepts manipulations of play control from the input unit. The play control includes, for example, actions to pause, resume, fast-forward, and rewind the play. When any of the manipulations of the play control is inputted, the control function of control device SP passes the control event caused by the manipulation on to the control function of viewing device SK. Upon receipt of the control event, the control function of viewing device SK processes the control event and performs the play control on the content being played. When control device SP is set to cause a control event without an input from the input unit, such as a control event to pause the play of the content in the case of an incoming call, the control event is also passed on from the control function of control device SP to the control function of viewing device SK. In the above-mentioned example, the ongoing play of the content by viewing device SK is paused.

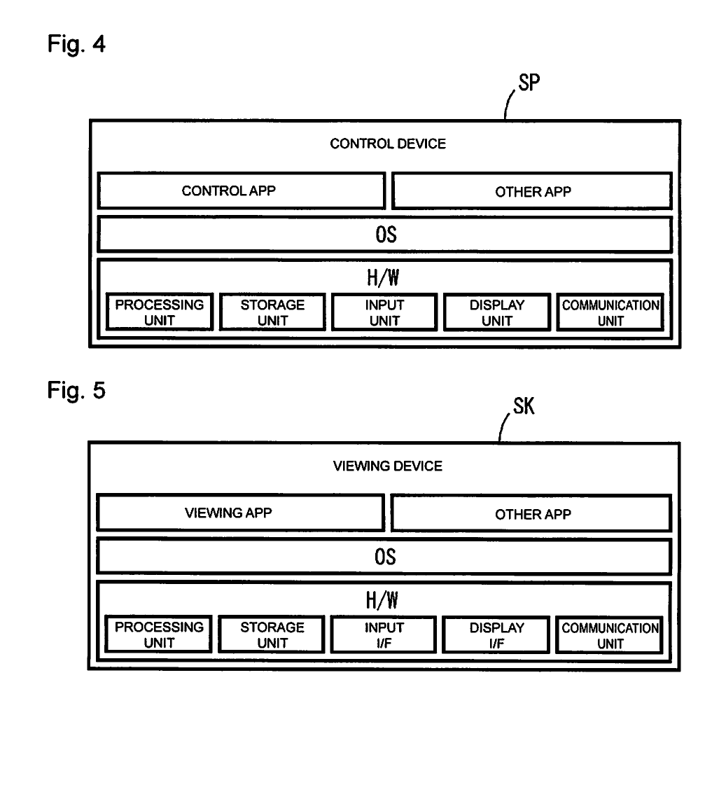

Control device SP configured to operate as described above has a configuration illustrated in FIG. 4. In the embodiment, control device (smartphone) SP includes constituents as a computer, executes an OS (Operating System) on a variety of hardware (H/W), and further executes various application programs (apps) on the OS.

The hardware includes a processing unit that realizes various functions by execution of programs, and the storage unit configured to store information to be used for processing by the processing unit. Moreover, the hardware includes the input unit to allow the user to input information, and the display unit designed to display the information for the sake of the user. Furthermore, the hardware includes a communication unit for communicating with viewing device SK. In the embodiment, the input unit includes a touch panel or an audio input unit while the display unit includes a liquid crystal display. As described previously, the communication unit includes Wi-Fi interface.

The control app and other apps are started on the OS. The various operations described above are performed by execution of the control app by the processing unit.

Subsequently, a configuration of viewing device SK is illustrated in FIG. 5. In the embodiment, viewing device SK also includes constituents as a computer, executes an OS (Operating System) on a variety of hardware (H/W), and further executes various application programs (apps) on the OS.

The hardware includes a processing unit that realizes various functions by execution of programs, and the storage unit configured to store information to be used for processing by the processing unit. Moreover, the hardware includes an input interface (input I/F) to establish connection to the input unit, and a display interface (display I/F) to establish connection to the display unit. Furthermore, the hardware includes a communication unit for communicating with control device SP. In the embodiment, the input I/F is a USB terminal which is provided for the purpose of establishing connection to a USB-compatible device mainly at the time of maintenance. In addition, as described previously, the display I/F includes the HDMI terminal and the communication unit includes Wi-Fi interface.

The viewing app and other apps are started on the OS. The various operations described above are performed by execution of the viewing app by the processing unit.

According to the above-described embodiment, the communication with the content server is performed not only by the viewing device corresponding to the digital media receiver but also by the control device, and a single content viewing service is provided to the user by the cooperation of the processing distributed to both of the devices. This makes it possible to reduce resources required by the viewing device and to downsize the viewing device as compared to a conventional viewing device.

1. A content viewing system comprising:
a viewing device that transmits a video content acquired from a contents server to an output unit connectable with the viewing device; and
a control device that controls the viewing device, wherein
the control device acquires from the content server options for purchasable video contents, causes a display unit to display the options, accepts from an input unit a manipulation for determination of a video content to be purchased out of the options, and sends the viewing device a control event caused from the manipulation for determination,
the viewing device executes purchase processing for the video content, which is determined to be purchased, on the basis of the control event received from the control device by communication with any of the content server and a transaction server cooperating with the content server, acquires the purchased video content from the content server, and plays the video content on the output unit,
the control device further causes a control event to control the play of the video content by the viewing device, and sends the viewing device the control event, and
the viewing device controls the play of the video content on the basis of the control event received from the control device.

2. A content viewing device comprising a processing unit that causes an output unit to play a video content acquired from a content server in response to a manipulation on a control device, wherein
the processing unit receives from the control device a control event caused by determination to purchase a video content in the control device, executes purchase processing for the video content, which is determined to be purchased, on the basis of the received control event by communication with any of the content server and a transaction server cooperating with the content server, acquires the purchased video content from the content server, and plays the video content on the output unit, and
the processing unit further receives a control event caused by the viewing device in order to control the play of the video content, and controls the play of the video content on the basis of the received control event.

3. The content viewing system of claim 1, wherein the control device includes a control application that is started by a manipulation of the input unit, the viewing device includes a viewing application that is started when the viewing device is turned on, and authentication processing is started for establishing a logical communication path between the control device and viewing device.

4. The content viewing system of claim 1, wherein the control device passes a program for the display function and a program for a control function to the viewing device, and the control device instructs the viewing device to install the display function and the control function on viewing device to execute the functions.

5. The content view system of claim 4, wherein the viewing device performs display function and the control function that are the same as the display function and the control function operated by the control device.

6. The content view system of claim 4, wherein the display function of viewing device displays on the output unit the same information as the information to be displayed on the display unit of the control device.
